(19) United States
(12) Patent Application Publication
(10) Pub. No.: US 2024/0294218 A1
(43) Pub. Date: Sep. 5, 2024

(54) MOBILE OBJECT

(71) Applicant: SONY GROUP CORPORATION, TOKYO (JP)

(72) Inventors: YASUHISA KAMIKAWA, TOKYO (JP); NORIAKI TAKASUGI, TOKYO (JP)

(21) Appl. No.: 18/258,303

(22) PCT Filed: Dec. 10, 2021
(86) PCT No.: PCT/JP2021/045492

§ 371 Date: Jun. 19, 2023

(30) Foreign Application Priority Data
Dec. 25, 2020 (JP) 2020-216293

(51) Int. Cl. B62D 57/024; B60B 19/00; B62D 61/10; B62D 61/12

(52) U.S. Cl. CPC B62D 57/024; B60B 19/003; B62D 61/10; B62D 61/12

(57) ABSTRACT

The present technology pertains to a mobile object configured so that a mobile object which performs multi-leg movement can stably move. The mobile object includes a body, a front left leg having a front left wheel, a front middle leg having a front middle wheel, a front right leg having a front right wheel, a rear left leg having a rear left wheel, a rear middle leg having a rear middle wheel, a rear right leg having a rear right wheel, and an operation control unit, the mobile object further including at least one of: a combination in which the left and right front wheels are drive wheels driven by the operation control unit, and the rear middle wheel is an omnidirectional wheel; or a combination in which the left and right rear wheels are drive wheels driven by the operation control unit, and the front middle wheel is an omnidirectional wheel. The present technology can be applied to, for example, a mobile object that transports a cargo.

### TECHNICAL FIELD

The present technology relates to a mobile object, and particularly relates to a mobile object that performs multi-leg movement.

### BACKGROUND ART

Conventionally, there has been proposed a robot that moves with six legs and carries, for example, a cargo at a construction site or a delivery site (see, for example, Patent Documents 1 and 2).

### CITATION LIST

### Patent Document

Patent Document 1: Japanese Patent Application Laid-Open No. 04-303083
Patent Document 2: Japanese Patent Application Laid-Open No. 62-143770

### SUMMARY OF THE INVENTION

### Problems to be Solved by the Invention

A mobile object that performs multi-leg movement as described in Patent Documents 1 and 2 is desired to have less risk of falling down and to be able to move stably.

The present technology has been achieved in view of such a situation, and an object thereof is to enable a mobile object performing multi-leg movement to move stably.

### Solutions to Problems

A mobile object according to one aspect of the present technology includes a body, a front left leg having a front left wheel, a front middle leg having a front middle wheel, a front right leg having a front right wheel, a rear left leg having a rear left wheel, a rear middle leg having a rear middle wheel, a rear right leg having a rear right wheel, and an operation control unit, the mobile object further including at least one of: a combination in which the left and right front wheels are drive wheels driven by the operation control unit, and the rear middle wheel is an omnidirectional wheel; or a combination in which the left and right rear wheels are drive wheels driven by the operation control unit, and the front middle wheel is an omnidirectional wheel.

In one aspect of the present technology, at least one of a set of the left and right front wheels or a set of the left and right rear wheels is driven, and at least one of the front middle wheel or the rear middle wheel passively rotates.

### BRIEF DESCRIPTION OF DRAWINGS

FIG. 1 is a perspective view of a mobile object to which the present technology is applied.

FIG. 2 is a front view of the mobile object to which the present technology is applied.

FIG. 3 is a left side view of the mobile object to which the present technology is applied.

FIG. 4 is a bottom view of the mobile object to which the present technology is applied.

FIG. 5 is a block diagram illustrating a configuration example of a portion related to movement of the mobile object to which the present technology is applied.

FIG. 6 is a diagram schematically illustrating how the mobile object goes up stairs.

FIG. 7 is a diagram schematically illustrating how the mobile object goes up stairs.

FIG. 8 is a diagram schematically illustrating how the mobile object goes up stairs.

FIG. 9 is a diagram schematically illustrating how the mobile object goes up stairs.

FIG. 10 is a diagram schematically illustrating how the mobile object goes up stairs.

FIG. 11 is a diagram schematically illustrating movement of wheels of the mobile object.

FIG. 12 is a diagram schematically illustrating how a mobile object provided with a horizontal linear joint goes up stairs.

FIG. 13 is a diagram schematically illustrating how the mobile object provided with the horizontal linear joint goes up stairs.

### MODE FOR CARRYING OUT THE INVENTION

Modes for carrying out the present technology will be described below. The description will be given in the following order.
1. Embodiment
2. Modification
3. Others

### 1. Embodiment

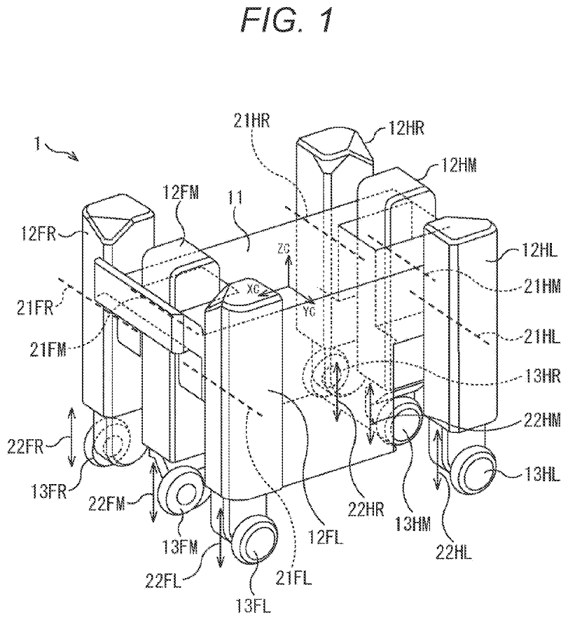

An embodiment of the present technology will be described with reference to FIGS. 1 to 11.

### <Configuration Example of Mobile Object 1>

First, a configuration example of the mobile object 1 according to the embodiment to which the present technology is applied will be described.

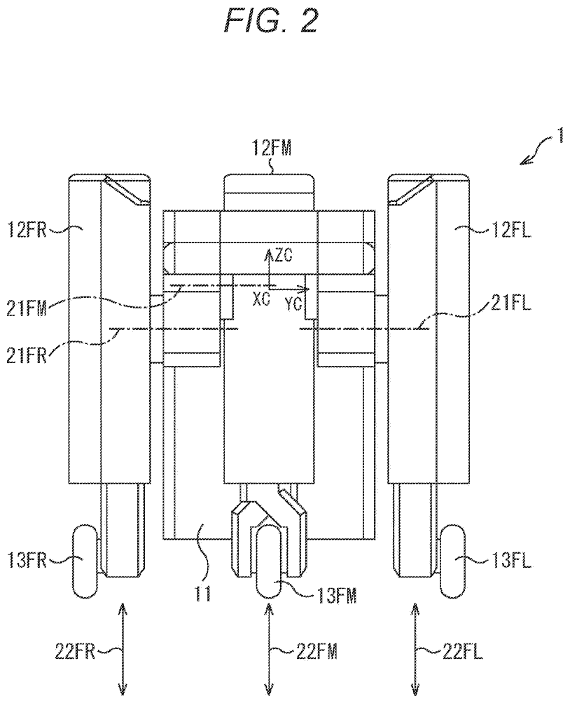

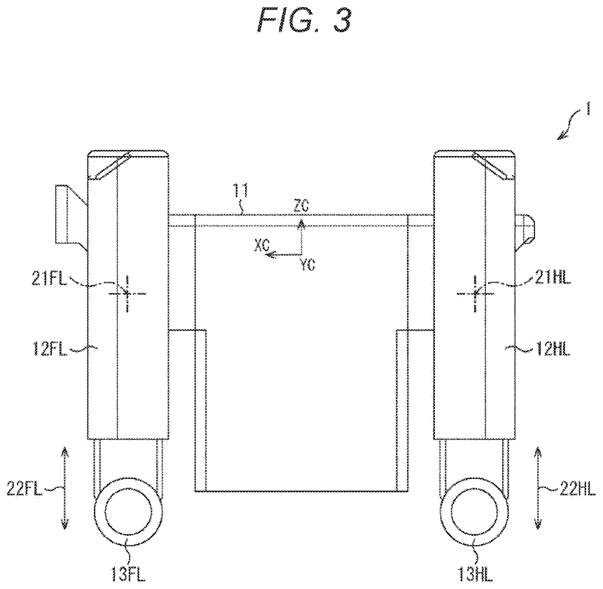

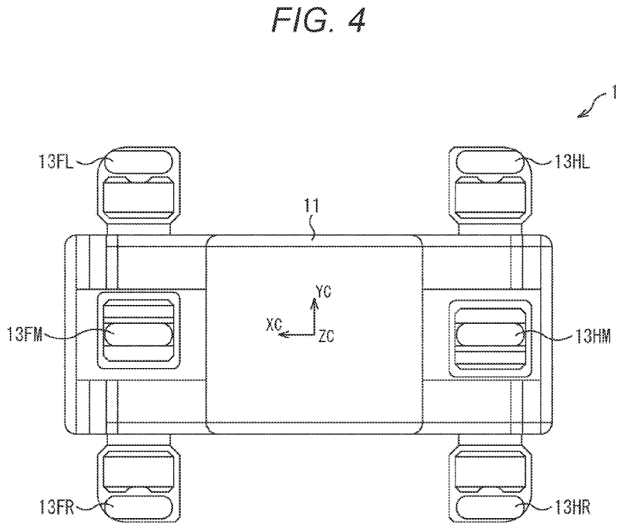

FIGS. 1 to 4 illustrate the configuration example of the external appearance of the mobile object 1. FIG. 1 is a perspective view of the mobile object 1. FIG. 2 is a front view of the mobile object 1. FIG. 3 is a left side view of the mobile object 1. FIG. 4 is a bottom view of the mobile object 1.

Note that, in the following description, an axis directed to the front of the mobile object 1 is referred to as an XC axis, an axis directed to the left is referred to as a YC axis, and an axis directed to the top is referred to as a ZC axis.

The mobile object 1 includes a body 11, a front left leg 12FL, a front middle leg 12FM, a front right leg 12FR, a rear left leg 12HL, a rear middle leg 12HM, and a rear right leg 12HR.

The body 11 has a shape close to a rectangular parallelepiped. Three front legs, that is, the front left leg 12FL, the front middle leg 12FM, and the front right leg 12FR are disposed adjacent to each other in the lateral direction on the front side of the body 11. Three front legs, that is, the rear left leg 12HL, the rear middle leg 12HM, and the rear right leg 12HR are disposed adjacent to each other in the lateral direction on the rear side of the body 11.

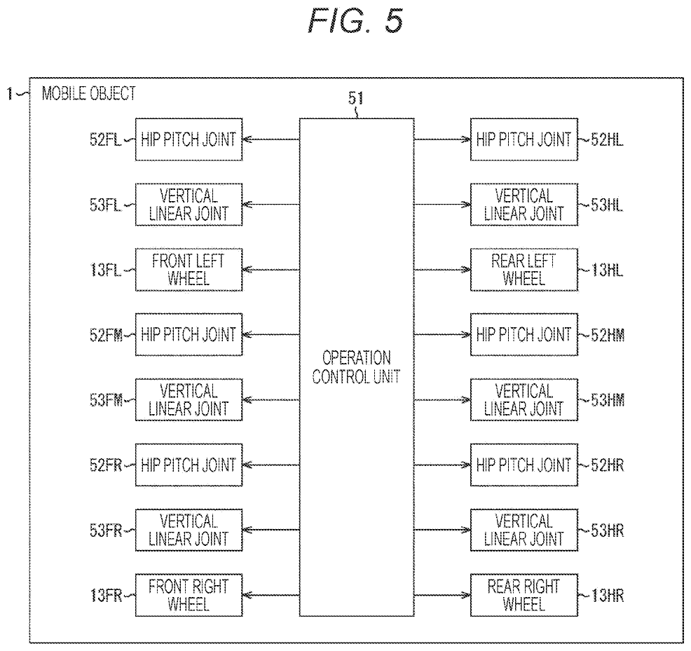

The front left leg 12FL is disposed on the front left side of the body 11. Specifically, the front left leg 12FL is connected to the vicinity of the front end of the left side face of the body 11 via a hip pitch joint 52FL (FIG. 5) so as to be rotatable in a pitch direction (vertical direction) around an axis 21FL that extends laterally. The front left leg 12FL includes a vertical linear joint 53FL (FIG. 5), and can extend and contract as indicated by an arrow 22FL. A front left wheel 13FL is provided at a leading end of the front left leg 12FL. The front left wheel 13FL is a drive wheel that is provided with an actuator such as a motor, and the like, the front left wheel 13FL being driven by the operation control unit 51 (FIG. 5) to rotate in the front-rear direction.

The front middle leg 12FM is disposed at the front side of and at the center of the body 11. Specifically, the front middle leg 12FM is connected to the vicinity of the center of the front face of the body 11 via a hip pitch joint 52FM (FIG. 5) so as to be rotatable in the pitch direction around an axis 21FM that extends laterally. The front middle leg 12FM includes a vertical linear joint 53FM (FIG. 5), and can extend and contract as indicated by an arrow 22FM. A front middle wheel 13FM is provided at a leading end of the front middle leg 12FM. The front middle wheel 13FM is a passive wheel (non-drive wheel) that passively rotates by a force applied from the outside, and is an omnidirectional wheel that can move in all directions. For example, an omni wheel, a wheel with casters, or a ball caster that passively rotates is used as the front middle wheel 13FM. Note that the wheel with casters may be of a type in which a caster portion is rotationally driven by a motor.

The front right leg 12FR is disposed on the front right side of the body 11. Specifically, the front right leg 12FR is connected to the vicinity of the front end of the right side face of the body 11 via a hip pitch joint 52FR (FIG. 5) so as to be rotatable in the pitch direction around an axis 21FR that extends laterally. The front right leg 12FR includes a vertical linear joint 53FR (FIG. 5), and can extend and contract as indicated by an arrow 22FR. A front right wheel 13FR is provided at a leading end of the front right leg 12FR. The front right wheel 13FR is a drive wheel that is provided with an actuator such as a motor, and the like, the front right wheel 13FR being driven by the operation control unit 51 (FIG. 5) to rotate in the front-rear direction.

The rear left leg 12HL is disposed on the rear left side of the body 11. Specifically, the rear left leg 12HL is connected to the vicinity of the rear end of the left side face of the body 11 via a hip pitch joint 52HL (FIG. 5) so as to be rotatable in the pitch direction around an axis 21HL that extends laterally. The rear left leg 12HL includes a vertical linear joint 53HL (FIG. 5), and can extend and contract as indicated by an arrow 22HL. A rear left wheel 13HL is provided at a leading end of the rear left leg 12HL. The rear left wheel 13HL is a drive wheel that is provided with an actuator such as a motor, and the like, the rear left wheel 13HL being driven by the operation control unit 51 (FIG. 5) to rotate in the front-rear direction.

The rear middle leg 12HM is disposed at the rear side of and at the center of the body 11. Specifically, the rear middle leg 12HM is connected to the vicinity of the center of the rear face of the body 11 via a hip pitch joint 52HM (FIG. 5) so as to be rotatable in the pitch direction around an axis 21HM that extends laterally. The rear middle leg 12HM includes a vertical linear joint 53HM (FIG. 5), and can extend and contract as indicated by an arrow 22HM. A rear middle wheel 13HM is provided at a leading end of the rear middle leg 12HM. The rear middle wheel 13HM is a passive wheel (non-drive wheel) that passively rotates by a force applied from the outside, and is an omnidirectional wheel that can move in all directions. For example, an omni wheel, a wheel with casters, or a ball caster that passively rotates is used as the rear middle wheel 13HM. Note that the wheel with casters may be of a type in which a caster portion is rotationally driven by a motor.

The rear right leg 12HR is disposed on the rear right side of the body 11. Specifically, the rear right leg 12HR is connected to the vicinity of the rear end of the right side face of the body 11 via a hip pitch joint 52HR (FIG. 5) so as to be rotatable in the pitch direction around an axis 21HR that extends laterally. The rear right leg 12HR includes a vertical linear joint 53HR (FIG. 5), and can extend and contract as indicated by an arrow 22HR. A rear right wheel 13HR is provided at a leading end of the rear right leg 12HR. The rear right wheel 13HR is a drive wheel that is provided with an actuator such as a motor, and the like, the rear right wheel 13HR being driven by the operation control unit 51 (FIG. 5) to rotate in the front-rear direction.

Note that, in the following, the front left leg 12FL, the front middle leg 12FM, the front right leg 12FR, the rear left leg 12HL, the rear middle leg 12HM, and the rear right leg 12HR are simply referred to as a leg 12 in a case where it is not necessary to individually distinguish them from each other. In the following, the front left leg 12FL, the front middle leg 12FM, and the front right leg 12FR are simply referred to as a front leg 12F in a case where it is not necessary to individually distinguish them from each other. In the following, the rear left leg 12HL, the rear middle leg 12HM, and the rear right leg 12HR are simply referred to as a rear leg 12H in a case where it is not necessary to individually distinguish them from each other.

In the following, the front left wheel 13FL, the front middle wheel 13FM, the front right wheel 13FR, the rear left wheel 13HL, the rear middle wheel 13HM, and the rear right wheel 13HR are simply referred to as a wheel 13 in a case where it is not necessary to individually distinguish them from each other. In the following, the front left wheel 13FL, the front middle wheel 13FM, and the front right wheel 13FR are simply referred to as a front wheel 13F in a case where it is not necessary to individually distinguish them from each other. In the following, the rear left wheel 13HL, the rear middle wheel 13HM, and the rear right wheel 13HR are simply referred to as a rear wheel 13H in a case where it is not necessary to individually distinguish them from each other.

FIG. 5 illustrates a configuration example of a portion related to the movement of the mobile object 1. In addition to the configuration described above with reference to FIGS. 1 to 4, the mobile object 1 includes the operation control unit 51, the hip pitch joint 52FL, the hip pitch joint 52FM, the hip pitch joint 52FR, the hip pitch joint 52HL, the hip pitch joint 52HM, the hip pitch joint 52HR, the vertical linear joint 53FL, the vertical linear joint 53FM, the vertical linear joint 53FR, the vertical linear joint 53HL, the vertical linear joint 53HM, and the vertical linear joint 53HR.

Note that, in the following, the hip pitch joints 52FL to 52HR are simply referred to as a hip pitch joint 52 in a case where it is not necessary to individually distinguish them from each other. In the following, the vertical linear joints 53FL to 53HR are simply referred to as a vertical linear joint 53 in a case where it is not necessary to individually distinguish them from each other.

The operation control unit 51 is implemented, for example, by a processor such as a CPU executing a control program. The operation control unit 51 controls various kinds of operation of the mobile object 1. For example, the operation control unit 51 controls the movement of the mobile object 1 by controlling the movement of each leg 12 and each wheel 13.

Specifically, the operation control unit 51 individually controls the rotation direction and the rotation speed of each of the front left wheel 13FL, the front right wheel 13FR, the rear left wheel 13HL, and the rear right wheel 13HR.

The operation control unit 51 controls the hip pitch joint 52FL to control the rotation of the front left leg 12FL in the pitch direction. The operation control unit 51 controls the hip pitch joint 52FM to control the rotation of the front middle leg 12FM in the pitch direction. The operation control unit 51 controls the hip pitch joint 52FR to control the rotation of the front right leg 12FR in the pitch direction. The operation control unit 51 controls the hip pitch joint 52HL to control the rotation of the rear left leg 12HL in the pitch direction. The operation control unit 51 controls the hip pitch joint 52HM to control the rotation of the rear middle leg 12HM in the pitch direction. The operation control unit 51 controls the hip pitch joint 52HR to control the rotation of the rear right leg 12HR in the pitch direction.

The operation control unit 51 controls the vertical linear joint 53FL to control the extension/contraction of the front left leg 12FL. The operation control unit 51 controls the vertical linear joint 53FM to control the extension/contraction of the front middle leg 12FM. The operation control unit 51 controls the vertical linear joint 53FR to control the extension/contraction of the front right leg 12FR. The operation control unit 51 controls the vertical linear joint 53HL to control the extension/contraction of the rear left leg 12HL. The operation control unit 51 controls the vertical linear joint 53HM to control the extension/contraction of the rear middle leg 12HM. The operation control unit 51 controls the vertical linear joint 53HR to control the extension/contraction of the rear right leg 12HR.

For example, the operation control unit 51 individually controls a joint mechanism (the hip pitch joint 52 and the vertical linear joint 53) of each leg 12 to move the leg 12 away from the ground in the traveling direction, thereby moving the mobile object 1. For example, the operation control unit 51 rotates the left and right front wheels 13F and the left and right rear wheels 13H in the traveling direction to thereby move the mobile object 1.

### <Moving Method of Mobile Object 1>

Next, a moving method of the mobile object 1 will be described.

### <Moving Method on Flat Ground>

First, a method for moving the mobile object 1 on a flat ground will be described.

Here, the flat ground is not necessarily a horizontal planar place, and may have some unevenness.

For example, the mobile object 1 can move on the flat ground while keeping the six legs 12 in contact with the ground.

Specifically, the left and right front wheels 13F and the left and right rear wheels 13H of the mobile object 1 are drive wheels as described above. Therefore, when the left and right front wheels 13F and the left and right rear wheels 13H rotate in the forward direction, the mobile object 1 moves forward. When the left and right front wheels 13F and the left and right rear wheels 13H rotate in the backward direction, the mobile object 1 moves backward.

In addition, the front middle wheel 13FM and the rear middle wheel 13HM are omnidirectional wheels as described above. Therefore, the mobile object 1 turns by, for example, differentially rotating the rear left wheel 13HL and the rear right wheel 13HR while keeping the front left wheel 13FL and the front right wheel 13FR away from the ground by lifting them by the vertical linear joint 53.

Here, differentially rotating the wheel 13 means that two or more wheels 13 rotate with different rotation speeds and/or rotation directions. For example, when the rear left wheel 13HL rotates in the forward direction at a rotation speed higher than that of the rear right wheel 13HR, the mobile object 1 turns clockwise. Note that a situation in which, for example, one wheel 13 rotates and the other wheel 13 does not rotate (that is, the rotation speed is zero) is also included in the case where the wheels 13 rotate differentially.

Note that the mobile object 1 turns by, for example, differentially rotating the front left wheel 13FL and the front right wheel 13FR while keeping the rear left wheel 13HL and the rear right wheel 13HR away from the ground by lifting them by the vertical linear joint 53.

In addition, the mobile object 1 can move forward or backward by alternately moving a set of three legs 12 including the front left leg 12FL, the front right leg 12FR, and the rear middle leg 12HM and a set of three legs 12 including the front middle leg 12FM, the rear left leg 12HL, and the rear right leg 12HR away from the ground and moving them in the traveling direction.

For example, the mobile object 1 moves the front left leg 12FL, the front right leg 12FR, and the rear middle leg 12HM away from the ground, moves them forward, and brings them in contact with the ground. Next, the mobile object 1 moves the front middle leg 12FM, the rear left leg 12HL, and the rear right leg 12HR away from the ground, moves them forward, and brings them in contact with the ground. Then, the mobile object 1 moves forward by repeating this operation.

At this time, the mobile object 1 can move forward faster by rotating the left and right wheels 13 of the legs 12 supporting the mobile object 1 in the forward direction during a free leg period of one set of legs 12. In addition, the mobile object 1 can change the traveling direction or turn by differentially rotating the wheels 13 of the left and right legs 12 among the three legs 12 supporting the mobile object 1 during the free leg period of one set of the legs 12.

As described above, the mobile object 1 is always supported by at least three legs 12, and the center of gravity of the mobile object 1 is located within a range of a triangle connecting the points of the three legs 12 in contact with the ground. Therefore, the mobile object 1 has a low risk of falling down, and can move forward and backward and turn in a stable state. In addition, while the mobile object 1 turns, one of a set of the left and right front wheels 13F and a set of the left and right rear wheels 13H is not in contact with the ground, so that friction with the ground is reduced. Therefore, the energy efficiency of the mobile object 1 is increased. Furthermore, the mobile object 1 can be turned without providing a steering drive mechanism, whereby the weight and cost of the mobile object 1 can be reduced.

### <Moving Method on Stairs>

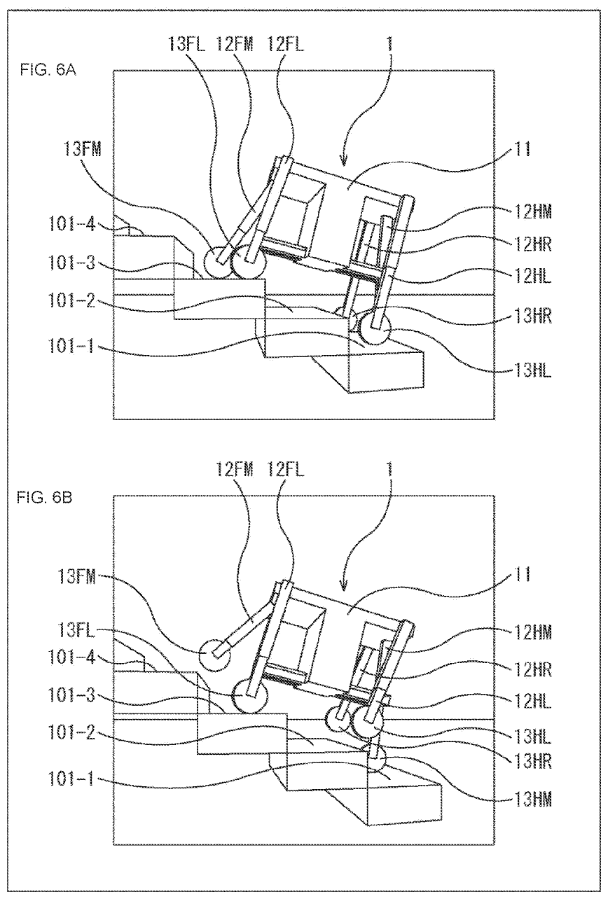

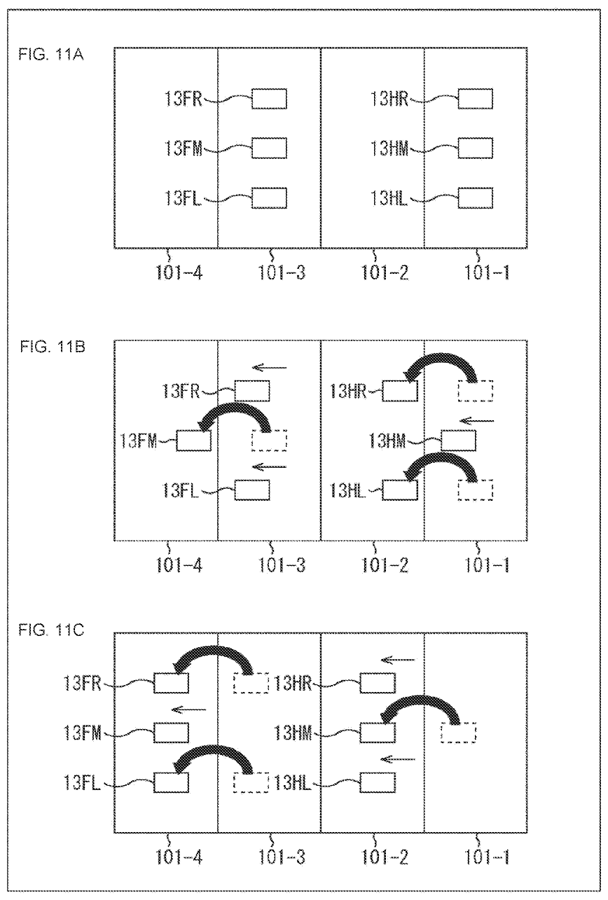

Next, a method for allowing the mobile object 1 to go up stairs will be described with reference to FIGS. 6 to 11. FIGS. 6 to 10 schematically illustrate how the mobile object 1 goes up stairs. FIG. 11 schematically illustrates movement of the wheels 13 of the mobile object.

Note that, in the following, a tread 101-1, a tread 101-2, a tread 101-3, . . . of stairs are simply referred to as a tread 101 in a case where it is not necessary to individually distinguish them from each other.

First, the front wheels 13F of the front legs 12F are in contact with the third tread 101-3, and the rear wheels 13H of the rear legs 12H are in contact with the first tread 101-1 which is two steps lower than the third tread 101-3 as illustrated in A of FIG. 6 and A of FIG. 11. In addition, the front middle wheel 13FM is located further to the front than the front left wheel 13FL and the front right wheel 13FR, and the rear middle wheel 13HM is located further to the rear than the rear left wheel 13HL and the rear right wheel 13HR. The body 11 is inclined according to the slope of the stairs. Specifically, the vertical axis of the body 11 is directed to a direction substantially perpendicular to the slope of the stairs, and the bottom surface of the body 11 is directed to a direction substantially parallel to the slope of the stairs.

Then, the front middle leg 12FM, the rear left leg 12HL, and the rear right leg 12HR contract and move away from the tread 101, and thus, are brought into a free leg state, as illustrated in B of FIG. 6. On the other hand, the mobile object 1 is supported by the front left leg 12FL (front left wheel 13FL) and the front right leg 12FR (front right wheel 13FR) that are still in contact with the tread 101-3 and the rear middle leg 12HM (rear middle wheel 13HM) which is still in contact with the tread 101-1.

Next, the front middle leg 12FM, the rear left leg 12HL, and the rear right leg 12HR, which are free legs, move forward as illustrated in B of FIG. 11. In addition, the front left wheel 13FL and the front right wheel 13FR which are in contact with the tread 101 rotate in the forward direction, by which the mobile object 1 moves forward. During this movement, the traveling direction of the mobile object 1 can be adjusted by differentially rotating the front left wheel 13FL and the front right wheel 13FR to turn the mobile object 1.

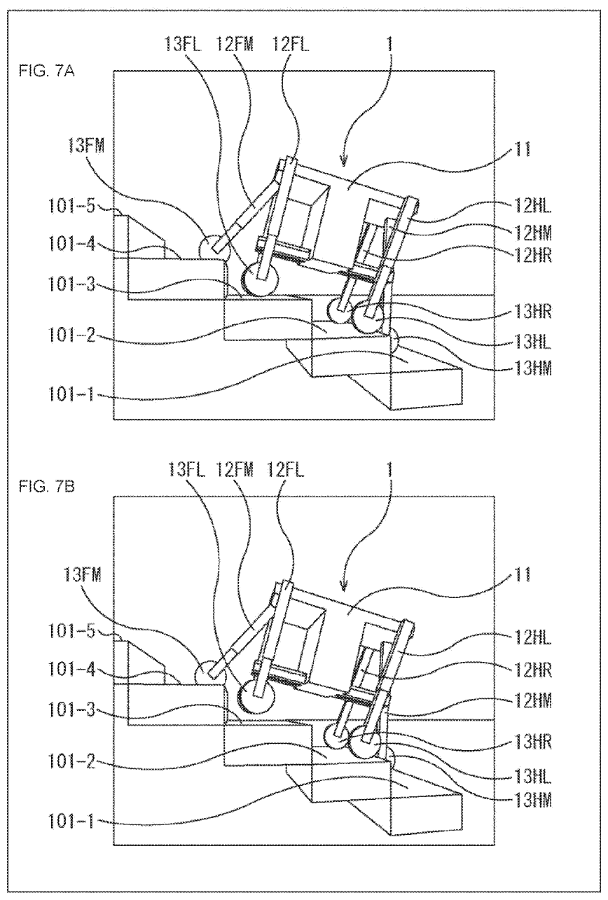

Next, the front middle leg 12FM (front middle wheel 13FM) which is currently a free leg extends and comes in contact with the tread 101-4, and the rear left leg 12HL (rear left wheel 13HL) and the rear right leg 12HR (rear right wheel 13HR) extend and come in contact with the tread 101-2 as illustrated in A of FIG. 7 and B of FIG. 11. During this movement, the rear left leg 12HL and the rear right leg 12HR come in contact with the tread 101-2 so as to be substantially perpendicular to the tread 101-2.

In this manner, the mobile object 1 is supported at three points that are the front left leg 12FL, the front right leg 12FR, and the rear middle leg 12HM during the free leg period of the front middle leg 12FM, the rear left leg 12HL, and the rear right leg 12HR. At this time, the center of gravity of the mobile object 1 is located within a range of a triangle connecting the above three points, so that the mobile object 1 is stably supported. Therefore, the risk of falling down is reduced.

In addition, the joint mechanism of each leg 12 is controlled such that the vertical axis of the body 11 approaches the direction substantially perpendicular to the slope of the stairs during the free leg period of the front middle leg 12FM, the rear left leg 12HL, and the rear right leg 12HR. As a result, the center of gravity of the mobile object 1 is located at a lower position with respect to the slope of the stairs, so that the moment on which the center of gravity acts is reduced. Thus, the risk of falling of the mobile object 1 is reduced. In addition, the mobile object 1 can move at a high speed and at substantially constant speed, whereby energy efficiency and stability are improved.

Furthermore, during the free leg period of the front middle leg 12FM, the rear left leg 12HL, and the rear right leg 12HR, the front left wheel 13FL and the front right wheel 13FR rotate in the forward direction, and thus, the mobile object 1 moves forward. Thus, the movement ranges of the front middle leg 12FM, the rear left leg 12HL, and the rear right leg 12HR can be reduced. As a result, the ranges of movement and the rotation speed of the hip pitch joint 52 and the vertical linear joint 53 can be suppressed.

Next, the front left leg 12FL, the front right leg 12FR, and the rear middle leg 12HM contract and move away from the tread 101, and thus, are brought into a free leg state, as illustrated in B of FIG. 7. On the other hand, the mobile object 1 is supported by the front middle leg 12FM (front middle wheel 13FM) which is still in contact with the tread 101-4 and the rear left leg 12HL (rear left wheel 13HL) and the rear right leg 12HR (rear right wheel 13HR) that are still in contact with the tread 101-2.

Next, the front left leg 12FL, the front right leg 12FR, and the rear middle leg 12HM, which are free legs, move forward as illustrated in C of FIG. 11. In addition, the rear left wheel 13HL and the rear right wheel 13HR which are in contact with the tread 101 rotate in the forward direction, by which the mobile object 1 moves forward. During this movement, the traveling direction of the mobile object 1 can be adjusted by differentially rotating the rear left wheel 13HL and the rear right wheel 13HR to turn the mobile object 1.

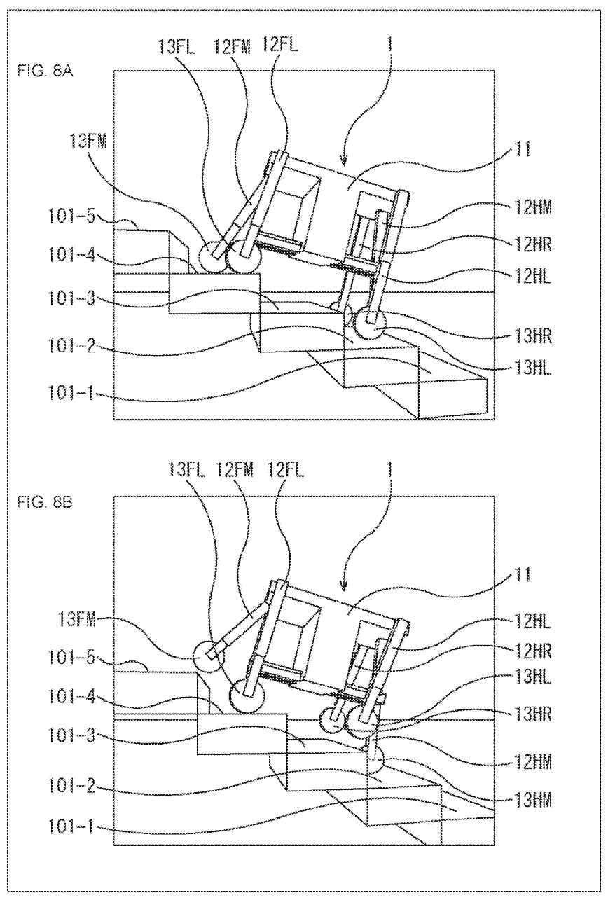

Next, the front left leg 12FL (front left wheel 13FL) and the front right leg 12FR (front right wheel 13FR) which are currently free legs extend and come in contact with the tread 101-4, and the rear middle leg 12HM (rear middle wheel 13HM) extends and comes in contact with the tread 101-2 as illustrated in A of FIG. 8 and C of FIG. 11. During this movement, the front left leg 12FL and the front right leg 12FR come in contact with the tread 101-4 so as to be substantially perpendicular to the tread 101-4.

In this manner, the mobile object 1 is supported at three points that are the front middle leg 12FM, the rear left leg 12HL, and the rear right leg 12HR during the free leg period of the front left leg 12FL, the front right leg 12FR, and the rear middle leg 12HM. At this time, the center of gravity of the mobile object 1 is located within a range of a triangle connecting the above three points, so that the mobile object 1 is stably supported. Therefore, the risk of falling down is reduced.

In addition, the joint mechanism of each leg 12 is controlled such that the vertical axis of the body 11 approaches the direction substantially perpendicular to the slope of the stairs during the free leg period of the front left leg 12FL, the front right leg 12FR, and the rear middle leg 12HM. As a result, the center of gravity of the mobile object 1 is located at a lower position with respect to the slope of the stairs, so that the moment on which the center of gravity acts is reduced. Thus, the risk of falling of the mobile object 1 is reduced. In addition, the mobile object 1 can move at a high speed and at substantially constant speed, whereby energy efficiency and stability are improved.

Furthermore, during the free leg period of the front left leg 12FL, the front right leg 12FR, and the rear middle leg 12HM, the rear left wheel 13HL and the rear right wheel 13HR rotate in the forward direction, and thus, the mobile object 1 moves forward. Thus, the movement ranges of the front left leg 12FL, the front right leg 12FR, and the rear middle leg 12HM can be reduced. As a result, the ranges of movement and the rotation speed of the hip pitch joint 52 and the vertical linear joint 53 can be suppressed.

In addition, the three front legs 12F can be simultaneously placed on the same tread 101 and the three rear legs 12H can be simultaneously placed on the same tread 101, whereby the mobile object 1 can go up the stairs without interference between the legs 12.

Then, as illustrated in B of FIG. 8, the front middle leg 12FM, the rear left leg 12HL, and the rear right leg 12HR contract and move away from the tread 101, and thus, are brought into a free leg state, as in the case described with reference to B of FIG. 6. On the other hand, the mobile object 1 is supported by the front left leg 12FL (front left wheel 13FL) and the front right leg 12FR (front right wheel 13FR) that are still in contact with the tread 101-4 and the rear middle leg 12HM (rear middle wheel 13HM) which is still in contact with the tread 101-2.

Next, the front middle leg 12FM, the rear left leg 12HL, and the rear right leg 12HR, which are free legs, move forward. In addition, the front left wheel 13FL and the front right wheel 13FR which are in contact with the tread 101 rotate in the forward direction, by which the mobile object 1 moves forward.

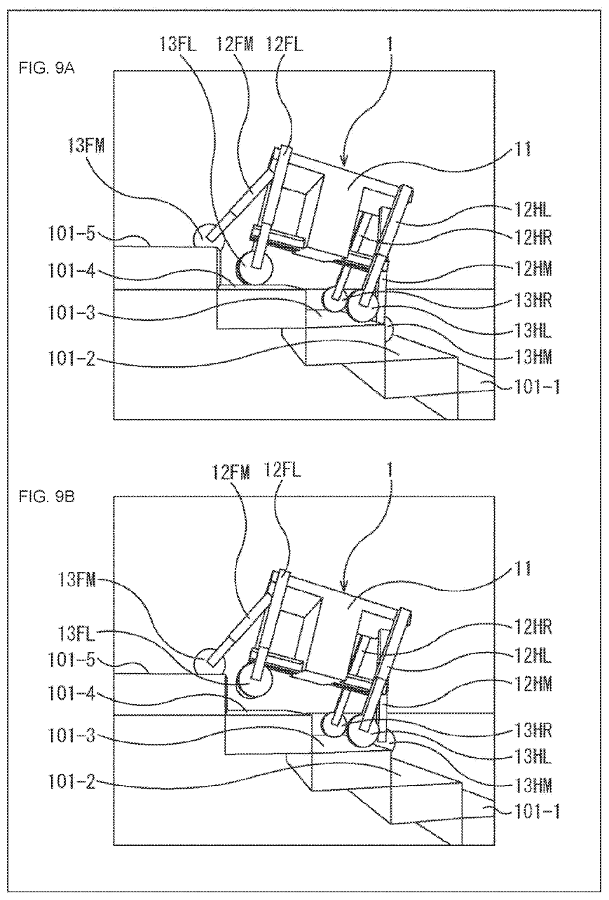

Next, as illustrated in A of FIG. 9, the front middle leg 12FM which is currently a free leg extends and comes in contact with the tread 101-5, and the rear left leg 12HL and the rear right leg 12HR extend and come in contact with the tread 101-3, as in the case described above with reference to A of FIG. 7.

Next, as illustrated in B of FIG. 9, the front left leg 12FL, the front right leg 12FR, and the rear middle leg 12HM contract and move away from the tread 101, and thus, are brought into a free leg state, as in the case described above with reference to B of FIG. 7. On the other hand, the mobile object 1 is supported by the front middle leg 12FM (front middle wheel 13FM) which is still in contact with the tread 101-5 and the rear left leg 12HL (rear left wheel 13HL) and the rear right leg 12HR (rear right wheel 13HR) that are still in contact with the tread 101-3.

Next, the front left leg 12FL, the front right leg 12FR, and the rear middle leg 12HM, which are free legs, move forward. In addition, the rear left wheel 13HL and the rear right wheel 13HR which are in contact with the tread 101 rotate in the forward direction, by which the mobile object 1 moves forward.

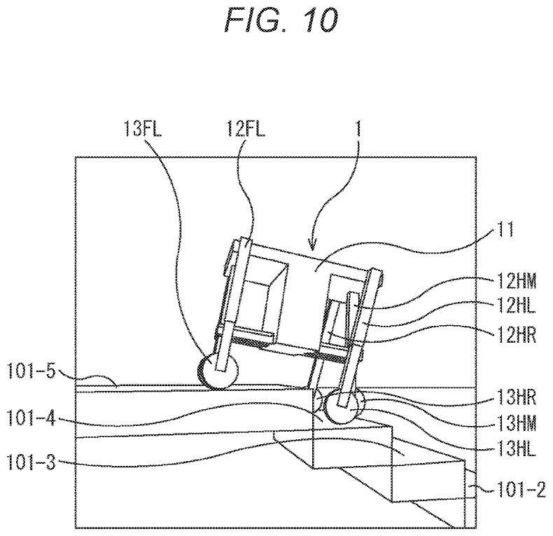

Next, as illustrated in FIG. 10, the front left leg 12FL and the front right leg 12FR which are currently free legs extend and come in contact with the tread 101-4, and the rear middle leg 12HM extends and comes in contact with the tread 101-2, as in the case described above with reference to A of FIG. 8.

Thereafter, the similar operation is repeated when the mobile object 1 further goes up the stairs.

Note that, in a case where the mobile object 1 goes down the stairs, an operation reverse to the above-described operation is performed.

As described above, the mobile object 1 can stably move on flat ground or go up and down stairs with less risk of falling down. In addition, the mobile object 1 can smoothly move at a substantially constant speed while reducing an increase or decrease in speed of the center of gravity of the mobile object 1 in an uneven ground including stairs. Accordingly, energy efficiency and stability of the mobile object 1 are improved.

In addition, due to each leg 12 including the hip pitch joint 52, a degree of freedom in arrangement of the leading end of each leg 12 is increased, and the mobile object 1 can go up and down stairs having various shapes even if the mobile object 1 is downsized.

Furthermore, as described above, the ranges of movement and the rotation speeds of the hip pitch joint 52 and the vertical linear joint 53 during the movement of going up and down the stairs can be suppressed, whereby the size of the mobile object 1 can be reduced.

### 2. Modification

Hereinafter, modifications of the above-described embodiment of the present technology will be described.

### <Modification Related to Moving Method>

The above description has given the example in which each leg 12 moves in the upward direction one step at a time when the mobile object 1 goes up the stairs. However, each leg may move in the upward direction two or more steps at a time. Here, in a case where each leg 12 of the mobile object 1 moves upward n steps at a time, the number of steps between the front legs 12F and the rear legs 12H of the mobile object 1 when the front legs 12F are in contact with the same tread 101 and the rear legs 12H are in contact with the same tread 101 is set to n+1 or more. For example, in a case where each leg 12 of the mobile object 1 moves upward two steps at a time, the number of steps between the front legs 12F and the rear legs 12H of the mobile object 1 when the front legs 12F are in contact with the same tread 101 and the rear legs 12H are in contact with the same tread 101 is set to three or more.

Furthermore, the mobile object 1 may move, for example, only with the legs 12 without having the wheels 13 in the legs 12. Specifically, the mobile object 1 can move by always alternately moving a set of three legs 12 including the front left leg 12FL, the front right leg 12FR, and the rear middle leg 12HM and a set of three legs 12 including the front middle leg 12FM, the rear left leg 12HL, and the rear right leg 12HR away from the ground and moving them in the traveling direction.

### <Modification Regarding Leg and Joint>

For example, the front middle leg 12FM may not be arranged alongside a front left leg 212FL and a front right leg 212FR, but may be arranged to be offset to the front or to the rear with respect to the front left leg 212FL and the front right leg 212FR. Similarly, the rear middle leg 12HM may not be arranged alongside a rear left leg 212HL and a rear right leg 212HR, but may be arranged to be offset to the front or to the rear with respect to the rear left leg 212HL and the rear right leg 212HR.

Furthermore, instead of the hip pitch joint 52, a horizontal linear joint that translates each leg in the front-rear direction with respect to the body may be provided, for example.

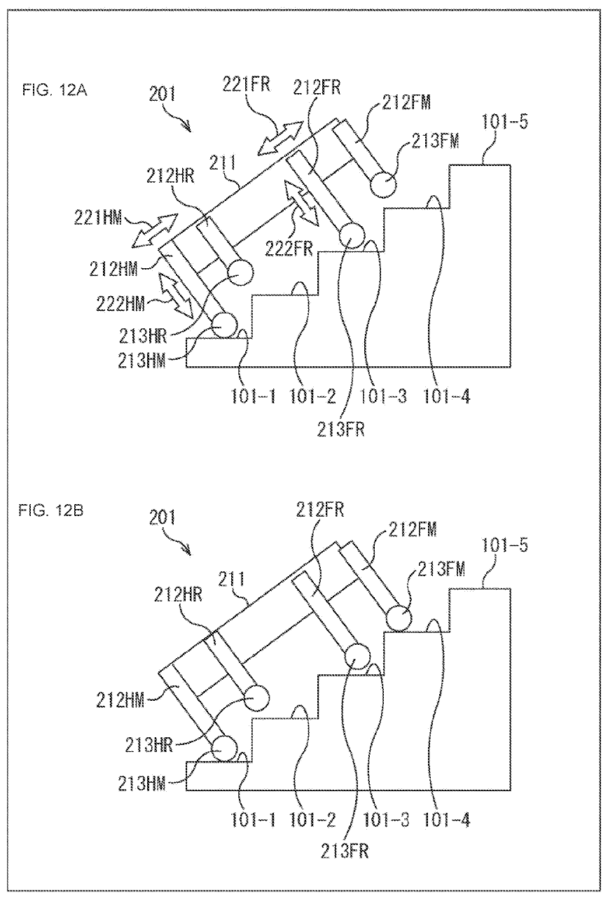

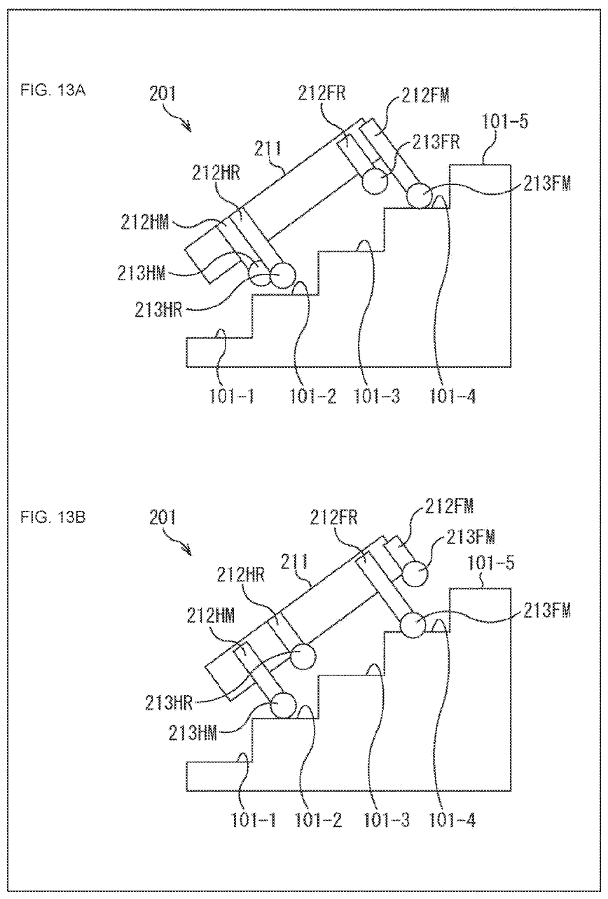

FIGS. 12 and 13 schematically illustrate how a mobile object 201 provided with a horizontal linear joint (not illustrated) goes up stairs.

The mobile object 201 includes a body 211, a front left leg 212FL (not illustrated), a front middle leg 212FM, a front right leg 212FR, a rear left leg 212HL (not illustrated), a rear middle leg 212HM, and a rear right leg 212HR.

The front right leg 212FR is connected to the front right side of the body 211 via the horizontal linear joint (not illustrated) so as to be translated in the front-rear direction as indicated by an arrow 221FR. The front right leg 212FR includes a vertical linear joint (not illustrated), and can extend and contract as indicated by an arrow 222FR. A front right wheel 213FR similar to the front right wheel 13FR in FIG. 1 is provided at a leading end of the front right leg 212FR.

Note that the front left leg 212FL, the rear left leg 212HL, and the rear right leg 212HR are disposed on the front left side, the rear left side, and the rear right side of the body 211, respectively, although not described in detail. The front left leg 212FL, the rear left leg 212HL, and the rear right leg 212HR each have the similar configuration to that of the front right leg 212FR, and can move in parallel in the front-rear direction and extend and contract. The front left leg 212FL, the rear left leg 212HL, and the rear right leg 212HR are respectively provided with a front left wheel 213FL (not illustrated), a rear left wheel 213HL (not illustrated), and a rear right wheel 213HR similar to the front left wheel 13FL, the rear left wheel 13HL, and the rear right wheel 13HR in FIG. 1.

The rear middle leg 212HM is connected to the rear side of the body 211 and at substantially the center of the body 211 in the lateral direction via the horizontal linear joint (not illustrated) so as to be translated in the front-rear direction as indicated by an arrow 221HM. The rear middle leg 212HM includes a vertical linear joint (not illustrated), and can extend and contract as indicated by an arrow 222HM. A rear middle wheel 213HM similar to the rear middle wheel 13HM in FIG. 1 is provided at a leading end of the rear middle leg 212HM.

Note that the front middle leg 212FM is disposed on the front side of the body 211 and near the center of the body 211 in the lateral direction, although not described in detail. The front middle leg 212FM has the similar configuration to the rear middle leg 212HM, and can move in parallel in the front-rear direction and extend and contract. A front middle wheel 213FM similar to the front middle wheel 13FM in FIG. 1 is provided at the leading end of the front middle leg 212FM.

Note that, in the following, the legs from the front left leg 212FL to the rear right leg 212HR are simply referred to as a leg 212 in a case where it is not necessary to individually distinguish them from each other.

As illustrated in A of FIG. 12 to B of FIG. 13, the mobile object 201 goes up the stairs by moving each leg 212 in a manner substantially similar to the manner of each leg 12 of the mobile object 1 described above. That is, the mobile object 1 can go up the stairs by alternately moving a set of the front middle leg 212FM, the rear left leg 212HL, and the rear right leg 212HR and a set of the front left leg 212FL, the front right leg 212FR, and the rear middle leg 212HM away from the ground and moving them upward.

It is to be noted that the mobile object 1 moves the legs 212 to an upper step by translating the legs 212 in the front-rear direction of the mobile object 1 by the horizontal linear joint after contracting them by the vertical linear joint. In addition, each leg 212 comes in contact with the tread 101 obliquely.

As described above, by providing the horizontal linear joint instead of the hip pitch joint, the holding torque in the horizontal direction may be reduced, and the power consumption of the mobile object 1 may be reduced.

### <Modification Regarding Wheel 13>

For example, the left and right front wheels 13F and the left and right rear wheels 13H, which are drive wheels, can be constituted by mecanum wheels. Thus, the mobile object 1 can also move in the lateral direction.

For example, the left and right front wheels 13F and the left and right rear wheels 13H, which are drive wheels, can be constituted by steerable drive wheels with casters (for example, the caster portion is rotationally driven by a motor). Thus, the mobile object 1 can also move in the lateral direction. In addition, it is possible to more stably turn the mobile object 1 from front to back and from side to side.

For example, one of the set of the left and right front wheels 13F and the set of the left and right rear wheels 13H may be constituted by drive wheels, and the other set may be constituted by omnidirectional wheels that passively rotate. In this case, the mobile object 1 can also be turned by differentially rotating the left and right drive wheels. Further, in this case, the left and right drive wheels can be constituted by steerable drive wheels with casters.

For example, one of the front middle wheel 13FM and the rear middle wheel 13HM may be constituted by a wheel that passively rotates in the front-rear direction instead of the omnidirectional wheel. Note that, in a case where the front middle wheel 13FM is constituted by a wheel that passively rotates in the front-rear direction, at least the left and right rear wheels 13H are constituted by drive wheels. In addition, in a case where the rear middle wheel 13HM is constituted by a wheel that passively rotates in the front-rear direction, at least the left and right front wheels 13F are constituted by drive wheels.

### <Other Modifications>

The shape of the body of the mobile object according to the present technology is not limited to the above-described example, and can be changed as necessary. For example, the body of the mobile object can have a human or animal shape. For example, it is possible to provide an arm on the body of the mobile object.

The application of the mobile object according to the present technology is not particularly limited. For example, the mobile object according to the present technology can be used for applications other than the above-described transportation of cargo at a construction site or a delivery site.

### 3. Others

The embodiment of the present technology is not limited to the above-described embodiment, and various modifications are possible without departing from the gist of the present technology.

### <Example of Combination of Configurations>

The present technology can have the following configurations.
(1)

A mobile object including
a body,
a front left leg having a front left wheel,
a front middle leg having a front middle wheel,
a front right leg having a front right wheel,
a rear left leg having a rear left wheel,
a rear middle leg having a rear middle wheel,
a rear right leg having a rear right wheel, and
an operation control unit,
the mobile object further including at least one of: a combination in which the left and right front wheels are drive wheels driven by the operation control unit, and the rear middle wheel is an omnidirectional wheel; or a combination in which the left and right rear wheels are drive wheels driven by the operation control unit, and the front middle wheel is an omnidirectional wheel.
(2)

The mobile object according to (1), further including
a plurality of joint mechanisms that individually moves the legs away from a ground and moves the legs in a traveling direction, in which
the operation control unit controls the joint mechanisms.
(3)

The mobile object according to (2), in which
each of the joint mechanisms includes:
a vertical linear joint that extends and contracts corresponding one of the legs; and
a pitch joint that rotates corresponding one of the legs in a pitch direction.
(4)

The mobile object according to (2), in which
each of the joint mechanisms includes:
a vertical linear joint that extends and contracts corresponding one of the legs; and
a horizontal linear joint that translates corresponding one of the legs in a front-rear direction.
(5)

The mobile object according to any one of (2) to (4), in which
the operation control unit moves the mobile object by alternately moving a first set including the front left leg, the front right leg, and the rear middle leg and a second set including the front middle leg, the rear left leg, and the rear right leg away from the ground and moving the first set and the second set in the traveling direction.
(6)

The mobile object according to (5), in which
the operation control unit causes the mobile object to go up stairs by alternately moving the first set and the second set away from the ground and moving the first set and the second set to an upper step by a predetermined number of steps.
(7)

The mobile object according to (6), in which
the operation control unit causes the mobile object to repeat an operation of moving, with all of the front legs in contact with a first tread and all of the rear legs in contact with a second tread that is lower than the first tread by a first number of steps, one of the first set and the second set to a tread upper by a second number of steps smaller than the first number of steps, and then moving another set of the first set and the second set to a tread upper by the second number of steps.
(8)

The mobile object according to (7), in which
the first number of steps is two, and the second number of steps is one.
(9)

The mobile object according to any one of (6) to (8), in which
the operation control unit controls the joint mechanisms such that an axis of the body in a vertical direction approaches a direction perpendicular to a slope of the stairs.
(10)

The mobile object according to any one of (5) to (9), in which
the operation control unit rotates, during a free leg period of one of the first set and the second set, the drive wheels of the left and right legs included in another set in the traveling direction.
(11)

The mobile object according to any one of (5) to (10), in which
the operation control unit rotates, during a free leg period of one of the first set and the second set, the drive wheels of the left and right legs included in another set differentially to turn the mobile object.
(12)

The mobile object according to any one of (1) to (11), in which
the operation control unit rotates at least one of a pair of the left and right front wheels or a pair of the left and right rear wheels differentially to turn the mobile object.
(13)

The mobile object according to any one of (1) to (12), in which
the left and right front wheels and the left and right rear wheels are the drive wheels.
(14)

The mobile object according to (13), in which
the drive wheel is a mecanum wheel.
(15)

The mobile object according to any one of (1) to (12), in which
one of a pair of the left and right front wheels and a pair of the left and right rear wheels is the drive wheel, and another pair is an omnidirectional wheel that passively rotates.
(16)

The mobile object according to any one of (1) to (15), in which
the drive wheel is a steerable drive wheel with casters.
(17)

The mobile object according to any one of (1) to (16), in which
the omnidirectional wheel is an omni wheel, a wheel with casters, or a ball caster.
(18)

The mobile object according to (17), in which
the wheel with casters has a caster portion that is rotationally driven by a motor.
(19)

The mobile object according to any one of (1) to (18), in which
the omnidirectional wheel passively rotates.
(20)

A mobile object including
a body,
a front left leg,
a front middle leg,
a front right leg,
a rear left leg,
a rear middle leg,
a rear right leg,
a plurality of joint mechanisms that moves the legs away from a ground and moves the legs in a traveling direction, and
an operation control unit that controls the joint mechanisms.
(21)

The mobile object according to (20), in which each of the joint mechanisms includes:
a vertical linear joint that extends and contracts corresponding one of the legs; and
a pitch joint that rotates corresponding one of the legs in a pitch direction.
(22)

The mobile object according to (20), in which
each of the joint mechanisms includes:
a vertical linear joint that extends and contracts corresponding one of the legs; and
a horizontal linear joint that translates corresponding one of the legs in a front-rear direction.
(23)

The mobile object according to any one of (20) to (22), in which
the operation control unit moves the mobile object by alternately moving a first set including the front left leg, the front right leg, and the rear middle leg and a second set including the front middle leg, the rear left leg, and the rear right leg away from the ground and moving the first set and the second set in the traveling direction.
(24)

The mobile object according to (23), in which
the operation control unit causes the mobile object to go up stairs by alternately moving the first set and the second set away from the ground and moving the first set and the second set to an upper step by a predetermined number of steps.
(25)

The mobile object according to (24), in which
the operation control unit causes the mobile object to repeat an operation of moving, with all of the front legs in contact with a first tread and all of the rear legs in contact with a second tread that is lower than the first tread by a first number of steps, one of the first set and the second set to a tread upper by a second number of steps smaller than the first number of steps, and then moving another set of the first set and the second set to a tread upper by the second number of steps.
(26)

The mobile object according to (25), in which
the first number of steps is two, and the second number of steps is one.
(27)

The mobile object according to any one of (24) to (26), in which
the operation control unit controls the joint mechanisms such that an axis of the body in a vertical direction approaches a direction perpendicular to a slope of the stairs.
(28)

The mobile object according to any one of (20) to (27), in which
the front left leg has a front left wheel,
the front middle leg has a front middle wheel,
the front right leg has a front right wheel,
the rear left leg has a rear left wheel,
the rear middle leg has a rear middle wheel, and
the rear right leg has a rear right wheel,
the mobile object further including at least one of: a combination in which the left and right front wheels are drive wheels driven by the operation control unit, and the rear middle wheel is an omnidirectional wheel; or a combination in which the left and right rear wheels are drive wheels driven by the operation control unit, and the front middle wheel is the omnidirectional wheel.
(29)

The mobile object according to (28), in which
the operation control unit moves the mobile object by alternately moving a first set including the front left leg, the front right leg, and the rear middle leg and a second set including the front middle leg, the rear left leg, and the rear right leg away from the ground and moving the first set and the second set in the traveling direction.
(30)

The mobile object according to (29), in which
the operation control unit causes the mobile object to go up stairs by alternately moving the first set and the second set away from the ground and moving the first set and the second set to an upper step by a predetermined number of steps.
(31)

The mobile object according to (30), in which
the operation control unit rotates, during a free leg period of one of the first set and the second set, the drive wheels of the left and right legs included in another set in the traveling direction.
(32)

The mobile object according to (30) or (31), in which
the operation control unit rotates, during a free leg period of one of the first set and the second set, the drive wheels of the left and right legs included in another set differentially to turn the mobile object.
(33)

The mobile object according to any one of (28) to (32), in which
the operation control unit rotates at least one of a pair of the left and right front wheels or a pair of the left and right rear wheels differentially to turn the mobile object.
(34)

The mobile object according to any one of (28) to (33), in which
the left and right front wheels and the left and right rear wheels are the drive wheels.
(35)

The mobile object according to (34), in which
the drive wheel is a mecanum wheel.
(36)

The mobile object according to any one of (28) to (33), in which
one of a pair of the left and right front wheels and a pair of the left and right rear wheels is the drive wheel, and another pair is an omnidirectional wheel that passively rotates.
(37)

The mobile object according to any one of (28) to (36), in which
the drive wheel is a steerable drive wheel with casters.
(38)

The mobile object according to any one of (28) to (37), in which
the omnidirectional wheel is an omni wheel, a wheel with casters, or a ball caster.
(39)

The mobile object according to (38), in which
the wheel with casters has a caster portion that is rotationally driven by a motor.
(40)

The mobile object according to any one of (28) to (39), in which
the omnidirectional wheel passively rotates.

Note that the effects described in the present description are merely examples and are not limited, and other effects may be provided.

### REFERENCE SIGNS LIST

1 Mobile object
11 Body
12FL Front left leg
12FM Front middle leg
12FR Front right leg
12HL Rear left leg
12HM Rear middle leg
12HR Rear right leg
13FL Front left wheel
13FM Front middle wheel
13FR Front right wheel
13HL Rear left wheel
13HM Rear middle wheel
13HR Rear right wheel
51 Operation control unit
52FL to 52HR Hip pitch joint
53FL to 53HR Vertical linear joint
201 Mobile object
211 Body
212FL Front left leg
212FM Front middle leg
212FR Front right leg
212HL Rear left leg
212HM Rear middle leg
212HR Rear right leg
213FL Front left wheel
213FM Front middle wheel
213FR Front right wheel
213HL Rear left wheel
213HM Rear middle wheel
213HR Rear right wheel

1. A mobile object comprising
a body,
a front left leg having a front left wheel,
a front middle leg having a front middle wheel,
a front right leg having a front right wheel,
a rear left leg having a rear left wheel,
a rear middle leg having a rear middle wheel,
a rear right leg having a rear right wheel, and
an operation control unit,
the mobile object further including at least one of: a combination in which the left and right front wheels are drive wheels driven by the operation control unit, and the rear middle wheel is an omnidirectional wheel; or a combination in which the left and right rear wheels are drive wheels driven by the operation control unit, and the front middle wheel is an omnidirectional wheel.

2. The mobile object according to claim 1, further comprising
a plurality of joint mechanisms that individually moves the legs away from a ground and moves the legs in a traveling direction, wherein
the operation control unit controls the joint mechanisms.

3. The mobile object according to claim 2, wherein
each of the joint mechanisms includes:
a vertical linear joint that extends and contracts corresponding one of the legs; and
a pitch joint that rotates corresponding one of the legs in a pitch direction.

4. The mobile object according to claim 2, wherein
each of the joint mechanisms includes:
a vertical linear joint that extends and contracts corresponding one of the legs; and
a horizontal linear joint that translates corresponding one of the legs in a front-rear direction.

5. The mobile object according to claim 2, wherein
the operation control unit moves the mobile object by alternately moving a first set including the front left leg, the front right leg, and the rear middle leg and a second set including the front middle leg, the rear left leg, and the rear right leg away from the ground and moving the first set and the second set in the traveling direction.

6. The mobile object according to claim 5, wherein
the operation control unit causes the mobile object to go up stairs by alternately moving the first set and the second set away from the ground and moving the first set and the second set to an upper step by a predetermined number of steps.

7. The mobile object according to claim 6, wherein
the operation control unit causes the mobile object to repeat an operation of moving, with all of the front legs in contact with a first tread and all of the rear legs in contact with a second tread that is lower than the first tread by a first number of steps, one of the first set and the second set to a tread upper by a second number of steps smaller than the first number of steps, and then moving another set of the first set and the second set to a tread upper by the second number of steps.

8. The mobile object according to claim 7, wherein
the first number of steps is two, and the second number of steps is one.

9. The mobile object according to claim 6, wherein
the operation control unit controls the joint mechanisms such that an axis of the body in a vertical direction approaches a direction perpendicular to a slope of the stairs.

10. The mobile object according to claim 5, wherein
the operation control unit rotates, during a free leg period of one of the first set and the second set, the drive wheels of the left and right legs included in another set in the traveling direction.

11. The mobile object according to claim 5, wherein
the operation control unit rotates, during a free leg period of one of the first set and the second set, the drive wheels of the left and right legs included in another set differentially to turn the mobile object.

12. The mobile object according to claim 1, wherein
the operation control unit rotates at least one of a pair of the left and right front wheels or a pair of the left and right rear wheels differentially to turn the mobile object.

13. The mobile object according to claim 1, wherein
the left and right front wheels and the left and right rear wheels are the drive wheels.

14. The mobile object according to claim 13, wherein
the drive wheel is a mecanum wheel.

15. The mobile object according to claim 1, wherein
one of a pair of the left and right front wheels and a pair of the left and right rear wheels is the drive wheel, and another pair is an omnidirectional wheel that passively rotates.

16. The mobile object according to claim 1, wherein
the drive wheel is a steerable drive wheel with casters.

17. The mobile object according to claim 1, wherein
the omnidirectional wheel is an omni wheel, a wheel with casters, or a ball caster.

18. The mobile object according to claim 17, wherein
the wheel with casters has a caster portion that is rotationally driven by a motor.

19. The mobile object according to claim 1, wherein
the omnidirectional wheel passively rotates.
